(19) United States
(12) Patent Application Publication
(10) Pub. No.: US 2025/0140221 A1
(43) Pub. Date: May 1, 2025

(54) Universal Modular Mechanical Assist Percussion Instrument Carrier

(71) Applicant: Randall May International Incorporated, Irvine, CA (US)

(72) Inventor: Randall L. MAY, Irvine, CA (US)

(21) Appl. No.: 18/933,892

(22) Filed: Oct. 31, 2024

Related U.S. Application Data
(60) Provisional application No. 63/595,203, filed on Nov. 1, 2023.

(51) Int. Cl. G10D 13/10; G10D 13/02

(52) U.S. Cl. CPC G10D 13/28; G10D 13/02

(57) ABSTRACT

A percussion instrument carrier bridge includes a bridge body and a plurality of mounting receivers. The bridge body includes a plurality of mounting receiver channels. Each mounting receiver is detachably mountable to a respective mounting receiver channel so as to reconfigure the percussion instrument carrier bridge to support a percussion instrument thereon in playing position.

### CROSS REFERENCE TO RELATED APPLICATION

This application claims priority to U.S. Provisional Appl. No. 63/595,203 filed on Nov. 1, 2023, the entire contents and disclosure of which is hereby expressly incorporated by reference herein.

This application is related to U.S. patent application Ser. No. 17/985,503, filed on Nov. 11, 2022, and to U.S. Provisional Appl. No. 63/504,711, filed on May 26, 2023, the entire contents and disclosures of which are hereby expressly incorporated by reference herein.

### BACKGROUND OF THE INVENTION

This disclosure relates generally to instrument support hardware, and more particularly to percussion instrument (e.g., snare/bass/tenor drum) carriers with bridge hardware that is readily reconfigurable to allow the percussion instrument carrier to support different percussion instruments thereon.

In percussion instrument performance and competition, it is challenging for instructors and performers to easily and efficiently locate the preferred position (i.e., playing surface height, angle, etc.) of the percussion instrument for the individual and to position the percussion instrument to that preferred position. These challenges are a consequence of variations along the drumline (and between drumlines) in height, arm length, posture, stick grip of the performers.

Such challenges are exacerbated by the fact that drumlines experience significant attrition over the various performance and competition seasons. As a consequence, drumlines frequently recruit new performers that may not have the same preferred instrument position as the performer they are replacing. The new recruits also may not have the requisite skill and/or physical ability to “fill in” for the performer they are replacing. This may result in a reshuffling of the drumline—i.e., more experienced performers switch instruments to account for the lower skill levels of newer recruits—in order to complete the ensemble voicing as best as possible. It is also not uncommon for performers to switch instruments due to lack of skill and/or physical ability (e.g., strength) to play their instrument of choice—which also further exacerbates the aforementioned challenges.

In order to meet these challenges, drumline programs (and band programs in general) have heretofore been forced to keep redundant instruments and carriers on hand to accommodate the rather large variations in performers' instrument usage and preferred playing positions. In short, adequately outfitting and equipping drumline performers is a constantly moving target. This adds significant costs that stretch the already limited budgets of percussion arts programs.

In addition, even with redundant instruments and carriers, real-time performance adjustments are challenging. The existing methodology of adjusting a playing surface while the instrument is being worn with a carrier can be very time consuming. Carriers and components using instrument support structures with specific dedicated abdomen bridges receiving longitudinal positioning supports are described in at least U.S. Pat. Nos. 7,326,842 and 8,646,666.

One adjustment method includes dismounting the instrument from the carrier with carrier remaining on the performer. The carrier support structure is then adjusted by the performer and locked to place at some estimate of where it should be to result in the preferred playing position. The drum is then remounted and the playing surface position is tested. The sequence is repeated until the preferred playing position is located. An alternative adjustment method involves an assistant lifting and supporting the instrument while the performer and/or the assistant adjusts the carrier support structure to some estimate of where it should be to result in the preferred playing position. The drum is then set again on the support structure and the playing surface position is tested, with the sequence being repeated until the preferred playing position is located.

Both adjusting methodologies typically require several repeated attempts to locate the absolute desired playing height position. Given the lengthy amount of time to accurately determine the correct position, neither of these methods can be accomplished in real-time during a performance. This is problematic, since small changes in playing position have large effects on performer technique and endurance, and thus a large impact on performance.

It is also becoming more common for performers to alternate between playing styles (e.g., grip techniques, etc.) to better serve the musical composition and visual performance. However, the preferred playing position is generally not consistent between different playing styles. Thus, changing playing styles very often results in needing to change the preferred playing position. Accordingly, in order to take advantage of alternating techniques during a performance, the playing position should be adjustable in real-time during the performance.

It is therefore desirable to provide a percussion instrument carrier with bridge hardware that can reconfigure the carrier to support any marching percussion instrument in way that permits adjusting the instrument to any preferred playing position and which eliminates the need to purchase redundant carriers to accommodate ever changing drumline personnel. The bridge hardware should be reconfigurable to allow the carrier to support any marching percussion instrument (e.g., bass, snare, tenor array) and should allow performers to adjust the playing surface position on demand in real-time during performances.

Other features and advantages of the present invention will become apparent from the following more detailed description, taken in conjunction with the accompanying drawings, which illustrate by way of example, the principles of the presently described embodiments.

### BRIEF DESCRIPTION OF THE DRAWINGS

FIG. 1 illustrates an exemplary SNARE carrier with a Modular/Airlift (mechanical assist) attachment in accordance at least one embodiment;

FIG. 2 illustrates an exploded exemplary SNARE carrier with a Modular/Airlift (mechanical assist) attachment in accordance at least one embodiment;

FIG. 3 illustrates an exemplary exploded (top view) SNARE structure with a Modular/Airlift (mechanical assist) attachment in accordance at least one embodiment;

FIGS, 4A-4F illustrate an exemplary Modular Universal Bridge with Modular receivers in accordance with at least one embodiment;

FIG. 5 illustrates an exemplary BASS drum carrier with a Modular/Airlift (mechanical assist) attachment in accordance at least one embodiment;

FIGS. 6-7 illustrate an exploded exemplary BASS drum carrier with a Modular/Airlift (mechanical assist) attachment in accordance at least one embodiment;

FIG. 8 illustrates an exemplary BASS drum carrier with a with a saddle attachment and Modular/Airlift (mechanical assist) attachment in accordance at least one embodiment;

FIG. 8 illustrates an exemplary BASS carrier with a saddle attachment in accordance with at least one embodiment.

FIG. 9 illustrates an exemplary TENOR carrier with a Modular/Airlift (mechanical assist) attachment in accordance at least one embodiment;

FIG. 10 illustrates an exemplary TENOR carrier with a Modular/Airlift (mechanical assist) attachment in accordance at least one embodiment;

FIG. 11 illustrates an exemplary exploded (top view) TENOR structure with a Modular/Airlift (mechanical assist) attachment in accordance at least one embodiment; and

FIGS. 12-13 illustrate an exemplary exploded (top view) Bi-Gas Spring TENOR structure with a Modular/Airlift (mechanical assist) attachment in accordance at least one embodiment.

### DETAILED DESCRIPTION OF THE PREFERRED EMBODIMENTS

The above described drawing figures illustrate the disclosed invention in at least one embodiment, which is further defined in detail in the following description. Those having ordinary skill in the art may be able to make alterations and modifications to what is described herein without departing from its spirit and scope. While this invention is susceptible of embodiment in many different forms, there is shown in the drawings and will herein be described in detail a preferred embodiment of the invention with the understanding that the present disclosure is to be considered as an exemplification of the principles of the invention and is not intended to limit the broad aspects of the invention to any embodiment illustrated. Therefore, it should be understood that what is illustrated is set forth only for the purposes of example and should not be taken as a limitation on the scope of the disclosed invention.

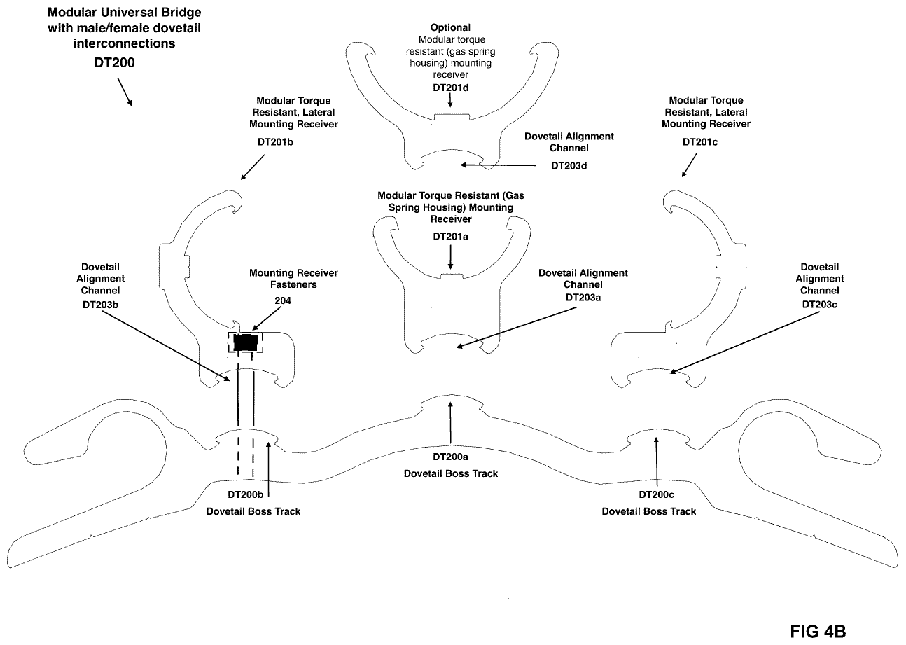

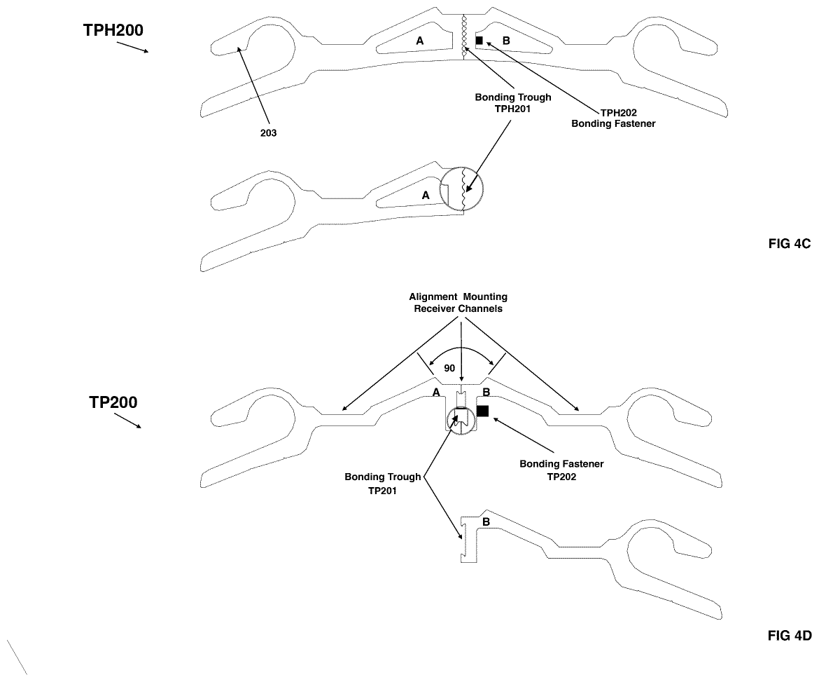

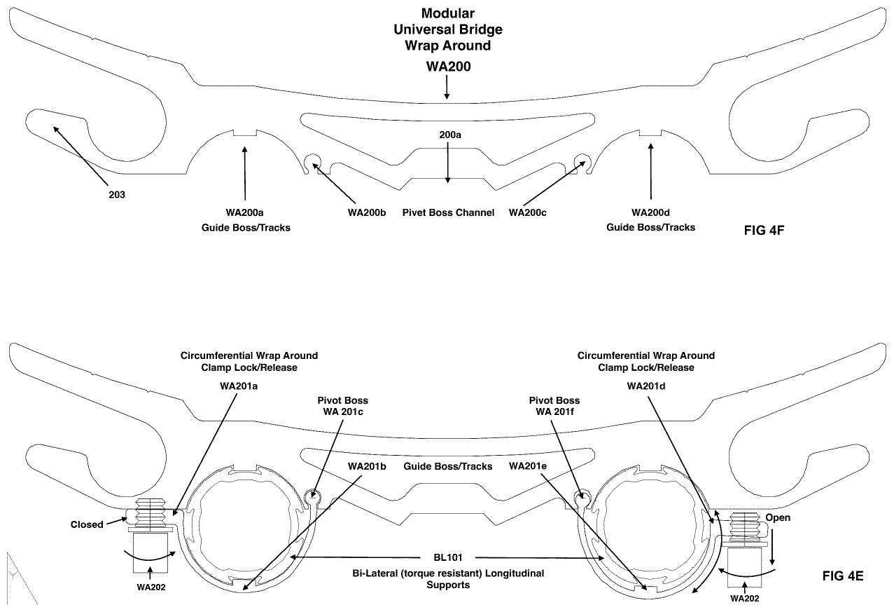

In general, the carrier is a user-wearable structure that functions to support an instrument (e.g., a drum or other marching band instrument) on a user's shoulders such that the instrument is positioned for playing by the user. A back member may connect the shoulder supports at the user's back. The frame may connect the shoulder supports as the user's front and may extend therefrom to the abb member on which the instrument support structure may be mounted. Accordingly, in operation, the shoulder supports may rest on the user's shoulders and thereby support the weight of the instrument that in-turn rests at least partially on the instrument support structure. The carrier can be any user-wearable structure that functions to support the instrument on a user's shoulders such that the instrument is positioned for playing by the user. In some embodiments (e.g., FIGS. 5-8) the carrier B600 comprises: a back member 504, a pair of shoulder supports 505, a tube chassis frame 501, an abdomen member 503 and an instrument support structure. Exemplary carriers and components thereof are described in at least the following: U.S. Pat. No. 7,326,842 filed on Dec. 23, 2004; U.S. Pat. No. 7,810,684 filed on Feb. 24, 2005; U.S. Pat. No. 7,394,008 filed on Apr. 22, 2005; U.S. Pat. No. 7,673,776 filed on Sep. 27, 2004; U.S. Pat. No. 7,166,790 filed on Nov. 6, 2006; U.S. Pat. No. 6,881,886 filed on Apr. 23, 2004; U.S. Pat. No. 7,420,110 filed on Dec. 23, 2004, the entire disclosures of which are incorporated herein by reference.

FIGS. 4A-4F illustrate universal modular bridge in detail. The instrument support structure comprises of a universal modular bridge 200 to receive the corresponding modular torque resistant mounting post/s receivers 201a-201d; DT201a-DT201d.

FIGS. 4A-4F shows an exemplary universal modular bridge 200 with alignment mounting receiver channels 200a, 200b and 200c. Alignment receiver channels 200a, 200b and 200c have 90-degree V-pocket flats that correspond to same 90-degree V-flats on receivers 201a, 201b, 201c and 201d. Alignment receiver channels serve an equally important function to properly align said modular torque resistant mounting receivers 201a, 201b 201c and 201d, when being mounted to bridge 200 by the performer. Bridge 200 allows one or all of the modular torque resistant mounting receivers 201a, 201b 201c and 201d to be interconnected/mounted with mounting fasteners 204 onto bridge 200.

FIGS. 4A-4F shows an exemplary Modular Universal Bridge with male/female dovetail interconnection DT 200, with alignment mounting receiver channel/s DT200a, DT200band DT200c. Alignment Receiver Channel/s DT200a, DT200b and DT200c have male dovetail profile that corresponds to mating, female dovetail channels DT203a, DT203b, DT203c and DT203d in respective receivers DT201, DT201b, DT201c and DT201d. Mating dovetail alignment channels serve an equally important function to properly align said Modular Torque Resistant Mounting Receivers DT201, DT201b,DT201c and DT201d when mounted to Bridge DT200 by the performer. Bridge DT 200 allows one or all of the Modular Torque Resistant Mounting Receivers DT201, DT201b, DT201c and DT201d to be interconnected/mounted with mounting fasteners 204 on Bridge DT200.

FIGS. 4A-4F shows exemplary Modular Universal Bridge Wrap Around WA200 with alignment mounting receiver Guide Boss/Tracks WA200a, WA200d. Alignment receiver Guide Boss/Tracks channels WA200a, WA200d have receiver pockets, WA200b and WA200c to interconnect circumferentially Wrap Around Clamp Lock/Release WA201a, WA201d respectively onto Pivot Boss WA 201c, WA 201f. Circumferentially Wrap Around Clamp Lock/Release WA201a, WA201d may also have Guide Boss/Tracks WA201b and WA201e to engage Bi-lateral Torque Resistant Longitudinal Supports BL101. It should be understood the Circumferentially Wrap Around Clamp Lock/Release WA201a, WA201d and/or Modular Universal Bridge Wrap Around WA200 have Guide Boss/Tracks that also act as a mechanical stop, preventing twist during deployment/compression and when in lockdown operation. IT is also contemplated any channel or pocket, similar in profile shape to other Bi-lateral Longitudinal Supports (less interlocking guide boss tracks) can be secured and guided with increased length of Circumferentially Wrap Around Clamp Lock/Release. To reposition BL-101 supports, loosen locking screw WA202 to allow Circumferentially Wrap Around Clamp Lock/Release WA201a, WA201d to open away from Bi-lateral Torque Resistant Longitudinal, Supports BL101 via Pivot Boss 201c, 201f inside receiver pockets WA 200b, WA200c.

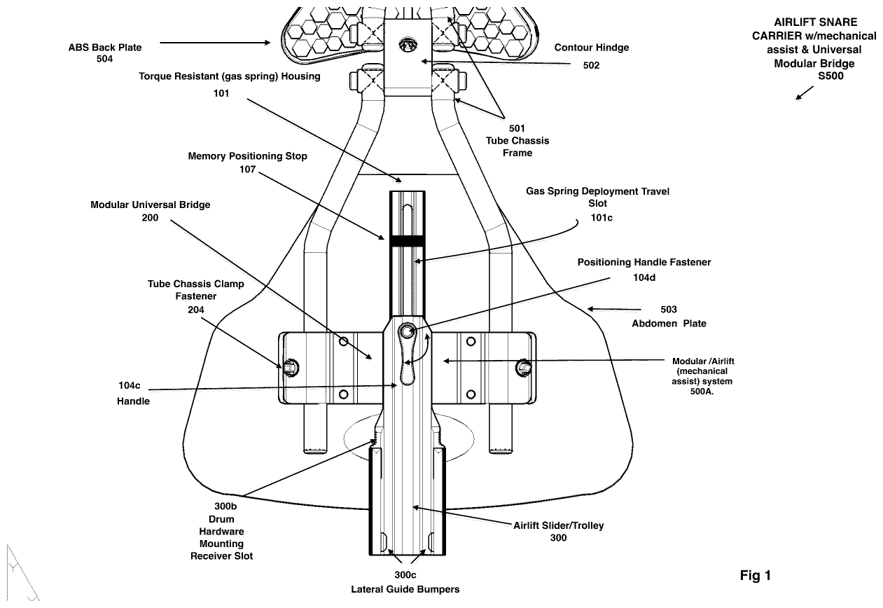

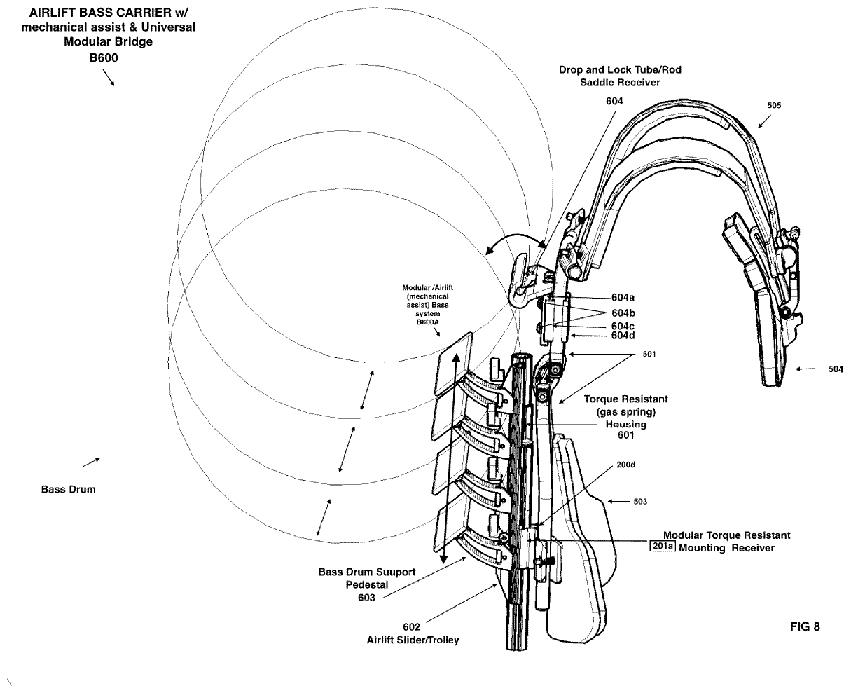

Upon securing at least one or any of three receivers 201a, 201b, 201c or 201d to Bridge 200 configures the modular Airlift carrier to a specific instrument carrier support structure shown in:
FIG. 1 AIRLIFT SNARE CARRIER S500 illustrates an exemplary Snare carrier as S500 with a Modular/Airlift (mechanical assist) System S500A and modular attachment system is in accordance with one or more embodiments.
FIG. 5 AIRLIFT BASS CARRIER B600 illustrates an exemplary Bass carrier as B600 with a Modular/Airlift (mechanical assist) System B600A and modular attachment system is in accordance with one or more embodiments.
FIG. 9 AIRLIFT TENOR CARRIER T700 illustrates an exemplary Tenor carrier as T700 with a Modular/Airlift (mechanical assist) System T700A and modular attachment system is in accordance with one or more embodiments,

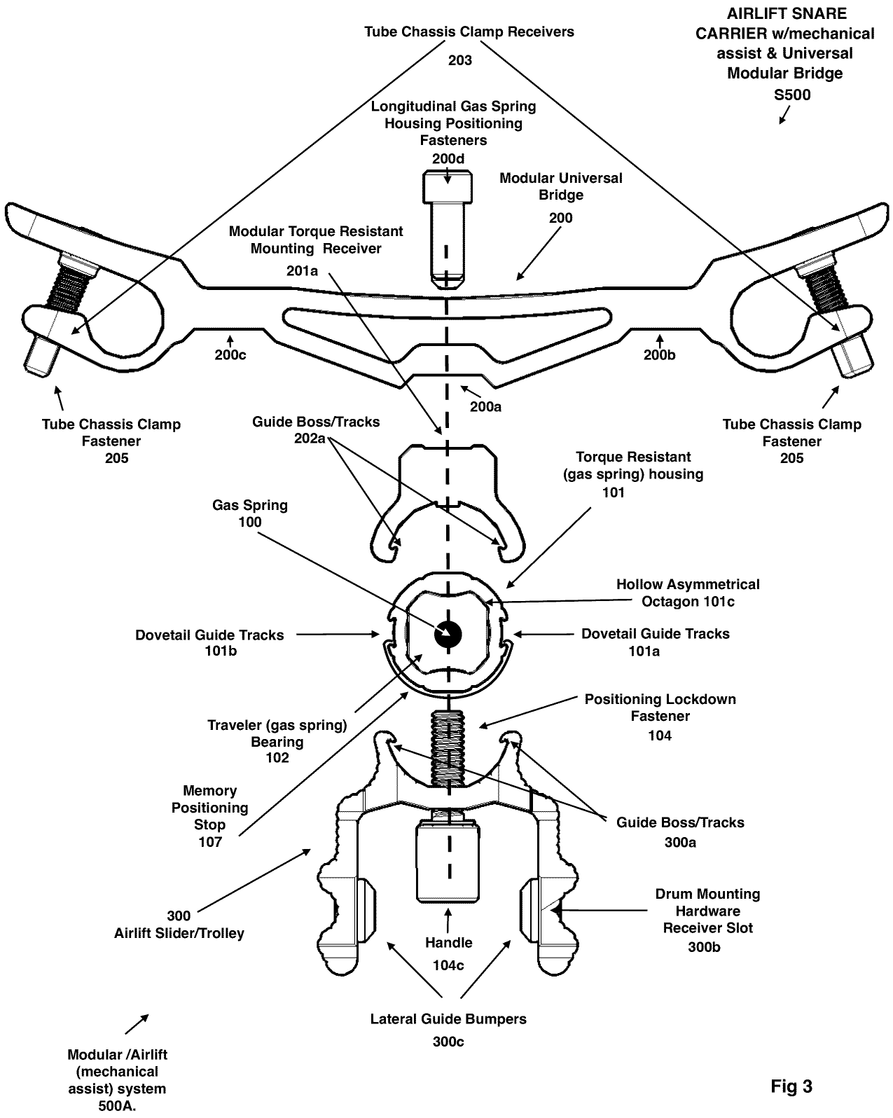

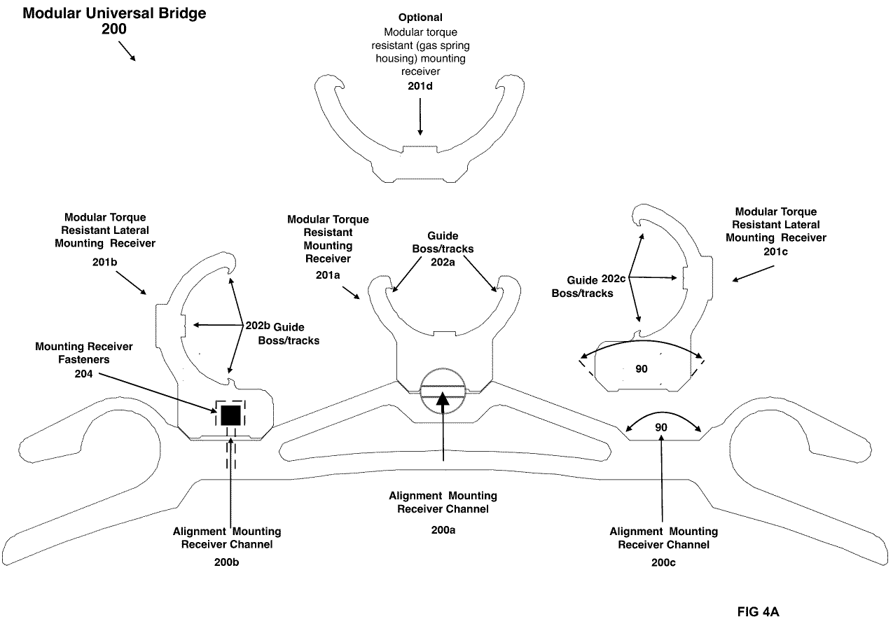

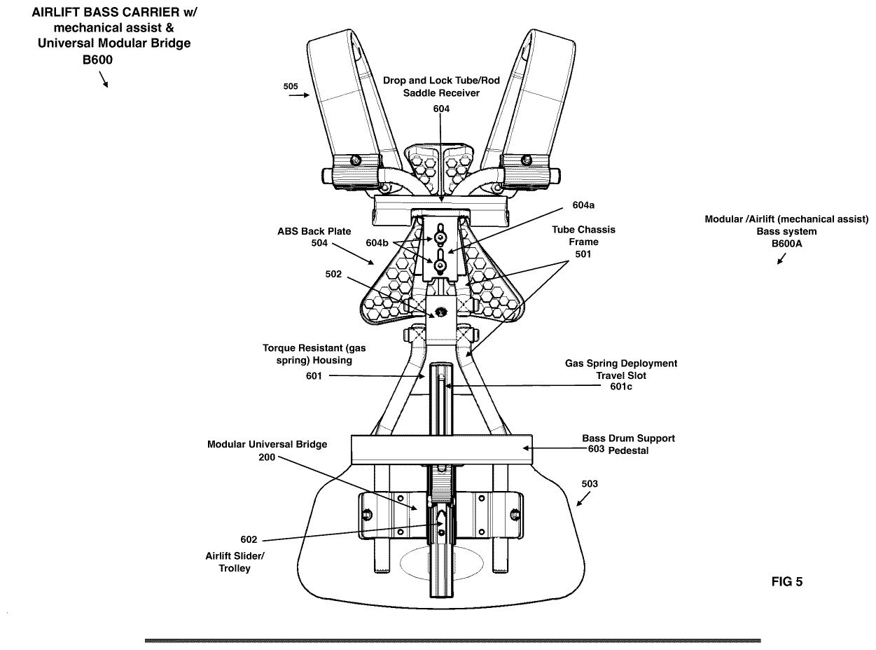

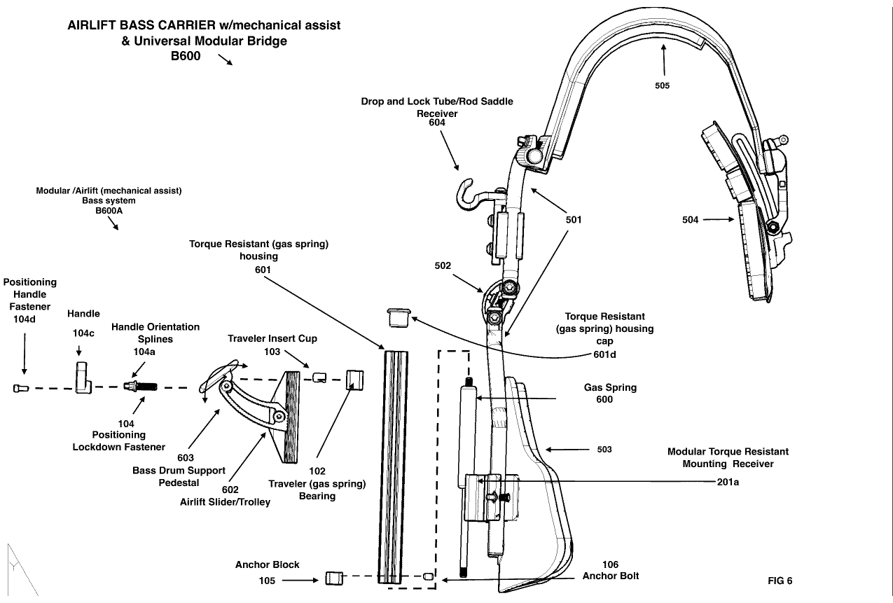

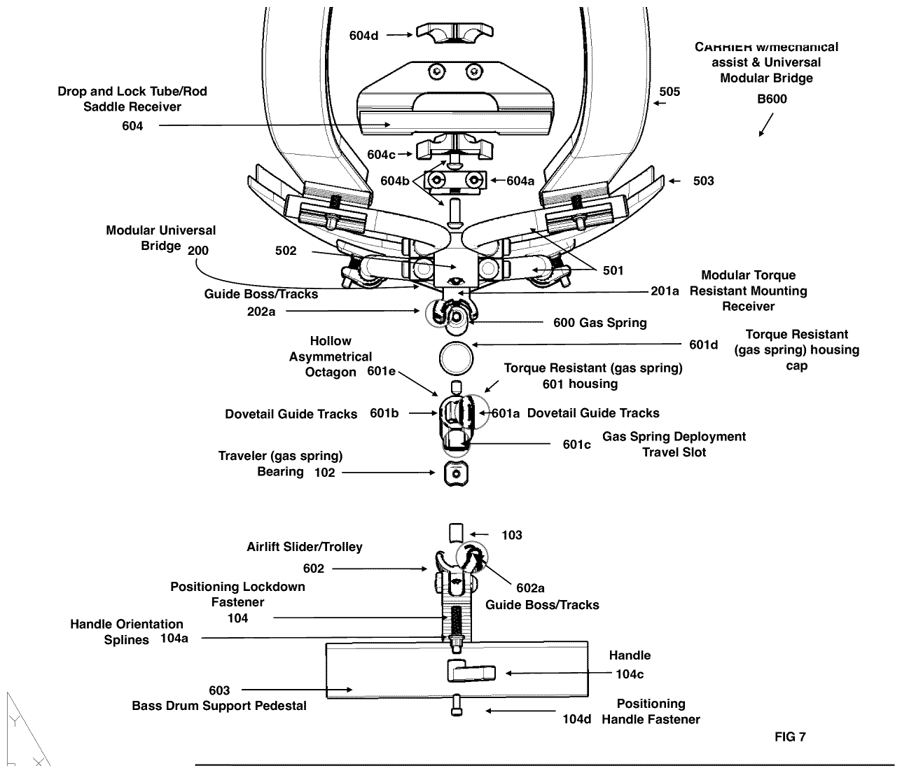

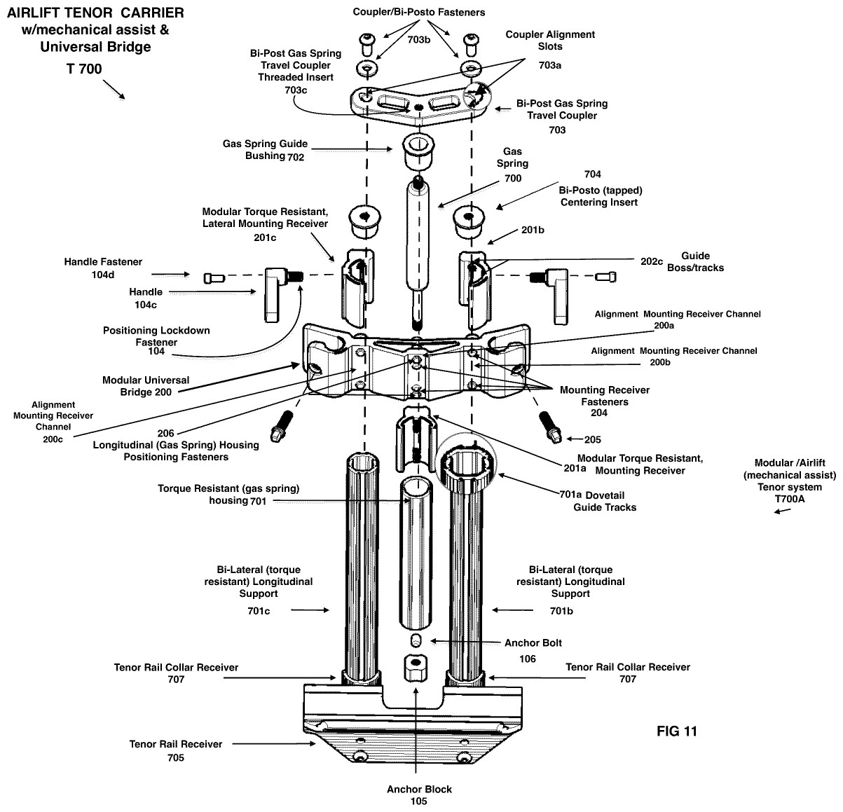

The carrier's modular Airlift mechanical-assists configuration, supporting different instrumentation/drum/s, will utilizes one or more gas spring housings 101, 601, 701 or 801b,801c. While all the presented mechanical-assist structures are shown as gas springs; compression springs, extension springs or a combination thereof can be substituted as an alternate mechanical assist. In addition, both compression spring and gas spring could be embodied into one structure, thus producing an accelerated launch rate of deployment. Said gas spring housings are slidably interconnected with corresponding Modular Torque Resistant Mounting Receivers 201a, 201b, 201c and 201d mounted to Universal Bridge 200. Torque Resistant Gas Spring Housings 101, 601, 701 or 801b, 801c have Dovetail Guide Tracks: FIG. 3 101a, 101b; FIG. 7 601a, 601b and FIG. 11 701a that slidably interlock with receivers 201a, 201b, 201c or 201d and their corresponding Guide Boss/Tracks FIG. 4 202a, 202b, 202c or 202d, Guide Boss/Tracks 202a, 202b, 202c or 202d serve to guide Gas Spring Housings 101, 601, 701 or 801b, 801c when repositioning their longitudinal travel. In addition, the modular Torque Resistant Mounting Receivers 201a, 201b, 201c or 201d and corresponding Guide Boss/Tracks 202a, 202b, 202c or 202d prevent torsional flexure when secured with Positioning Lockdown Fasteners 104 in desired longitudinal position.

Each function and operation of the three Modular Airlift carriers are described now with further operation details.

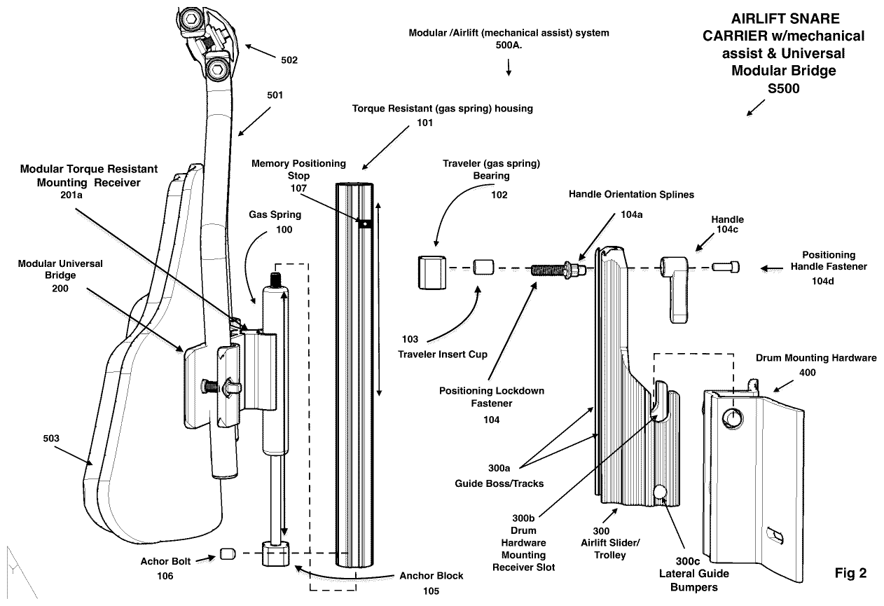

Turning now to FIGS. 1-3, the Universal Modular AIRLIFT SNARE CARRIER S500 is configured to support a marching snare drum (snare drum not shown). The snare drum is supported onto Airlift Slider Trolley 300 in Drum Mounting Hardware Receiver Slots 300b, Modular Torque Resistant Mounting Receiver 201a is mounted to Modular Universal Bridge 200 at Alignment Mounting Receiver Channel 200a via receiver fasteners FIG. 4 204. Torque Resistant Gas Spring Housing 101 is slidably interconnected with Modular Torque Resistant Mounting Receiver 201a and longitudinally positioned with Longitudinal Gas Spring Housing Positioning Fasteners FIG. 3 200d. Gas Spring 100 is interconnected inside Torque Resistant Gas Spring Housing 101 with Gas Spring 100 screwed into threaded Anchor Block 105. Anchor Block 105 is secured to Torque Resistant Gas Spring Housing 101 via Anchor Block Bolt 106 threaded into both Torque Resistant Gas Spring Housing 101 and Anchor Block 105. Traveler Gas Spring Bearing 102 is threaded onto upper end of Gas Spring 100. Traveler Gas Spring Bearing 102 has a matching profile to (inside) Hollow Asymmetrical Octagon 101c of Torque Resistant Gas Spring Housing 101. Torque Resistant Gas Spring Housing 101 is preferably made of light weight metals i.e. Aluminum or Magnesium and Traveler Gas Spring Bearing 102 is preferably constructed with a machinable polymer with good to excellent lubricity, as with Teflon or Acetal to mitigate drag (friction) in the deployment travel of the Gas Spring 100. Gas Spring 100 OD is undersized to that of Traveler Gas Spring Bearing 102 OD, thus allowing Gas Spring 100 to deploy or compress without interfering with inside Hollow Asymmetrical Octagon 101c. Traveler Gas Spring Bearing 102 is also undersized with micro-clearance, typically a few thousandths and further has a horizonal pocket to receive Traveler Insert Cup 103 (preferably constructed from metal) that receives Positioning Lockdown Fastener 104. Traveler Insert Cup 103 servers to protect Traveler Gas Spring Bearing 102 from repeated point loading/compression, while engaging the Positioning Lockdown Fastener 104. Positioning Lockdown Fastener 104 is threaded into Airlift Slider/Trolley 300 that passes through Gas Spring Deployment Travel Slot 101c and floats into Traveler Insert Cup 103; interconnecting both Gas Spring 100 and Airlift Slider Trolley 300 to move together as one embodiment when deploying Gas Spring 100 and/or compressing. Upon determining desired position of deployment/compression of Modular Airlift Mechanical Assist system 500A, Positioning Lockdown Fastener 104 is rotated (clockwise) to lock the position of Traveler Gas Spring Bearing 102 with lateral movement (approximately 0.005) positioning/compressing against the inside of Hollow Asymmetrical Octagon 101c wall. Positioning Lockdown Fastener 104 also simultaneously draws Airlift Slider/Trolley 300 away from Torque Resistant Gas Spring Housing 101 to engage Guide Boss/Tracks 300a of Airlift Slider/Trolley 300 to lock the complete assembly of Modular Airlift Mechanical Assist System 500A.

Airlift System 500A may also have Memory Positioning Stop 107 that is positioned longitudinally on Torque Resistant Gas Spring Housing 101 to mechanically interfere/stop Gas Spring 100 deployment to a preset preferred playing height. Memory Positioning Stop 107 allows the performer to lower the drum/s position for visual and/or when alternating between Match and Traditional grip. As previously disclosed, Traditional grip requires a slightly higher drum playing surface e in order to comfortably allow rotation and lift of the forearm+the wrist, without creating tension or unnecessary muscle engagement. However, in contrast, Match grip should utilize a moderately lower drum height, producing a comfortable position for both wrists to engage from and won't restrict the carpal tunnel by creating unwanted tension. The performer can adjust the preferred lowered positioning by first compressing Gas Spring 100 (to bottom of stroke) and lock. Lowered height adjustment is performed with positioning the Torque Resistant Gas Spring Housing 101 longitudinally within the Modular Torque Resistant Mounting Receiver 202a and secured with Longitudinal Gas Spring Housing Positioning Fasteners 200d. Deployment height is dictated by the position of Memory Positioning Stop 107. Performer can now reposition the drum in real time to either preferred lowered and/or higher playing height.

The Positioning Lockdown Fastener 104 has Handle Orientation Splines 104a to orientate the position of Handle 104c, secured with Positioning Handle Fastener 104d. To improve the performers ergonomic grasp of Handle 104c, reposition the orientation of Handle 104c by removing Positioning Handle Fastener 104d along with Handle 104c and reorientate to desired location (engaging splines 104a) then lock with Positioning Handle Fastener 104d.

It should be understood the Modular Airlift Mechanical Assist System 500A can be interchanged with different gas springs (higher or lower workforce) to accommodate variable weights of drums, along with ancillary percussion instruments being implemented/supported for expanding instruments to be played. Interchangeable, Modular Airlift Gas Springs with different workforces are beneficial to best achieve a nominal (neutral) work-force when repositioning the supported drum via the Modular Airlift Mechanical Assist System 500A. Modular Airlift Mechanical Assist System 500A structure also allows the cantilevered load of the drum while in a playing position to work in tandem with the Gas Spring 100 to temporally hold the deployment/reposition of the Gas Spring System 500A, prior to securing the Positioning Lockdown Fastener 104a. This feature allows the performer to implement small amounts of adjustment to achieve the precise playing height. An additional advantage of said tandem working relationship allows for the Gas Spring to be of lessor workforce to reposition the Airlift Slider/Trolley 300 with supported drum. When the performer loosens the Positioning Lockdown Fastener 104, followed with small degree of drum/s rotation (approximately 2-5 degrees upward toward the rest position), the cantilevered load is then neutralized, thus allowing the gas spring to mechanically assists repositioning system 500A upward along with the drums. If the performer desires to the lower the drum, the drum must now be further rotated to full rest position (90 degrees), utilizing the vertical load of the drum to somewhat neutralize the gas spring's upward force to apply modest downward force to reposition the drum lower.

Turning now to FIGS. 5-8, the Universal Modular AIRLIFT BASS CARRIER B600 is similar in operation as AIRLIFT SNARE CARRIER S500 but is configured specifically to support a marching Bass drum as shown in application U.S. patent application Ser. No. 17/985,503 filed on Nov. 11, 2022, the entire contents and disclosures of which are hereby expressly incorporated by reference herein. The Bass drum is supported by the Airlift Slider Trolley 602 in conjunction with Bass Drum Support Pedestal 603. Bass drum has mounting tube bridge (not shown) that is gravity fed into Drop and Lock Tube/Rod Saddle Receiver 604 that allows rotation within the said receiver saddle 604 as the Bass drum is repositioned upon deploying Modular Airlift Mechanical Assist Bass system B600A. Modular Torque Resistant Mounting Receiver 201a is mounted to Modular Universal Bridge 200 at Alignment Mounting Receiver Channel 200a via Mounting Receiver Fasteners FIG. 4 204. Torque Resistant Gas Spring Housing 601 is slidably interconnected with Modular Torque Resistant Mounting Receiver 201a and longitudinally positioned with Longitudinal Gas Spring Housing Positioning Fasteners FIG. 3 200d. Gas Spring 600 is interconnected inside Torque Resistant Gas Spring Housing 601 with Gas Spring 600 screwed into threaded Anchor Block 105. Anchor Block 105 is secured to Torque Resistant Gas Spring Housing 601 via Anchor Block Bolt 106 threaded into both Torque Resistant Gas Spring Housing 601 and Anchor Block 105. Traveler Gas Spring Bearing 102 is threaded onto upper end of Gas Spring 600. Traveler Gas Spring Bearing 102 has a matching profile to inside Hollow Asymmetrical Octagon 601e of Torque Resistant Gas Spring Housing 601. Torque Resistant Gas Spring Housing 601 is preferably made of light weight metals i.e. Aluminum or Magnesium and Traveler Gas Spring Bearing 102 is preferably constructed with a machinable polymer with good to excellent lubricity, as with Teflon or Acetal to mitigate drag/friction in the deployment travel of the Gas Spring 600. Gas Spring 600 OD is undersized to that of Traveler Gas Spring Bearing 102 OD thus allowing Gas Spring 600 to deploy or compress without interfering with inside Hollow Asymmetrical Octagon 601e. Traveler Gas Spring Bearing 102 is also undersized with micro clearance and further has a horizonal pocket to receive Traveler Insert Cup 103 (preferably constructed from metal) that receives Positioning Lockdown Fastener 104. Traveler Insert Cup 103 servers to protect Traveler Gas Spring Bearing 102 from repeated point loading/compression while engaging the Positioning Lockdown Fastener 104. Positioning Lockdown Fastener 104 is threaded into Airlift Slider/Trolley 602 and passes through Gas Spring Deployment Travel Slot 601c and floats into Traveler Insert Cup 103, interconnecting both Gas Spring 600 and Airlift Slider Trolley 602 to move together as one embodiment when deploying and/or compressing Gas Spring 600. Upon determining desired position of deployment/compression of Modular Airlift Mechanical Assist System B600A, Positioning Lockdown Fastener 104 is rotated (clockwise) to lock the position of Traveler Gas Spring Bearing 102 with lateral movement (approximately 0.005) positioning/compressing against the inside of Hollow Asymmetrical Octagon 601c wall, Positioning Lockdown Fastener 104 also simultaneously draws Airlift Slider/Trolley 602 away from Torque Resistant Gas Spring Housing 601 to engage Guide Boss/Tracks 602a of Airlift Slider/Trolley 602 to lock the complete assembly of Modular Airlift Mechanical Assist System B600A.

Airlift Bass System B600A may also have Memory Positioning Stop 107 that is positioned longitudinally on Torque Resistant Gas Spring Housing 601 to mechanically interfere/stop Gas Spring 600 compression or deployment to a preset, preferred playing height. Memory Positioning Stop 107 also allows the performer to lower (without stop interference) the drum's preferred playing height position while alternating to a higher position for visual and/or elevating the drum to have enhanced sonic projection. Performer can adjust the preferred lowered positioning by first compressing Gas spring 600 (to bottom of stroke) and lock. Followed with longitudinal height adjustment by positioning the Torque Resistant Gas Spring Housing 601 within the Modular Torque Resistant Mounting Receiver 202a and secured with Longitudinal Gas Spring Housing Positioning Fasteners 200d. Deployment height is dictated by the position of Memory Positioning Stop 107. Performer can now reposition the drum in real time to either preferred lowered and/or higher playing height.

As with the Modular Airlift Mechanical Assist System 500A, Modular Airlift Mechanical Assist Bass System B600A can be interchanged with different gas springs (higher or lower workforce) to accommodate variable weights of drums along with ancillary percussion instruments being implemented/supported for expanding instruments to be carried and played. Modular Airlift Mechanical Assist System B600A can have interchangeable gas springs with different workforces (as the name implies) that are beneficial to best achieve a nominal (neutral) workforce when repositioning the supported Bass drum. Modular Airlift Mechanical Assist System B600A structure also allows the cantilevered load of the Bass Drum (positioned in a playing position) to work in tandem with the Gas Spring 600 to temporally hold the reposition/deployment of the Modular Airlift Mechanical Assist System B600A, prior to securing the Positioning Lockdown Fastener 104. This feature allows the performer to apply micro amounts of adjustment to achieve a precise playing height. An additional advantage of said tandem working relationship, allows for the Gas Spring 600 to be of lessor workforce to reposition the Airlift Slider Trolley 602 including supported Bass drum. After the performer loosens the Positioning Lockdown Fastener 104, followed by a small degree of drum's rotation (approximately 2-5 degrees upward off the Bass Drum Support Pedestal 603), the cantilevered load is partially neutralized, thus allowing the gas spring to deploy (mechanically assist), repositioning Modular Airlift Mechanical Assist System B600A transitioning to become tangent with the Bass drum's shell. If the performer desires to the lower the bass drum, the bass drum remains in contact with Bass Drum Support Pedestal 603 to allow leverage and weight from the drum to assist the performer to reposition to a lower location.

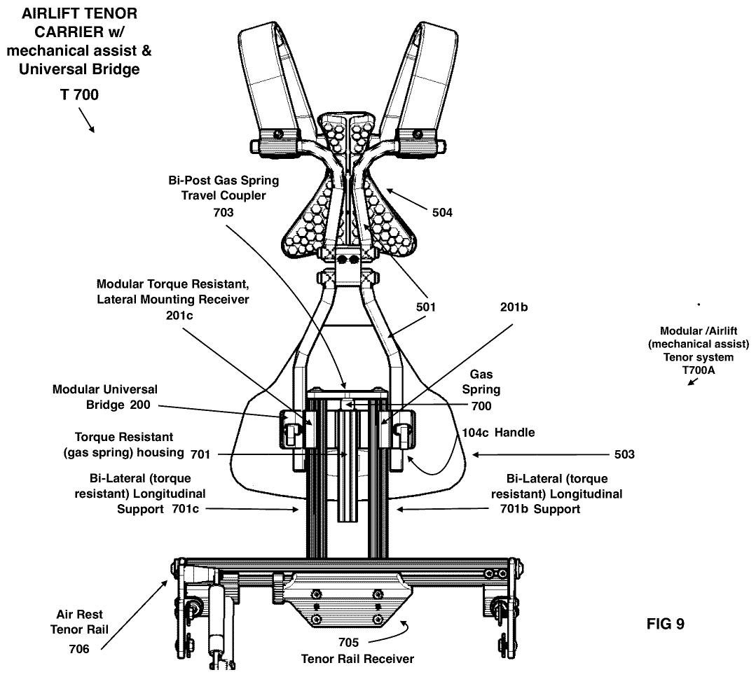

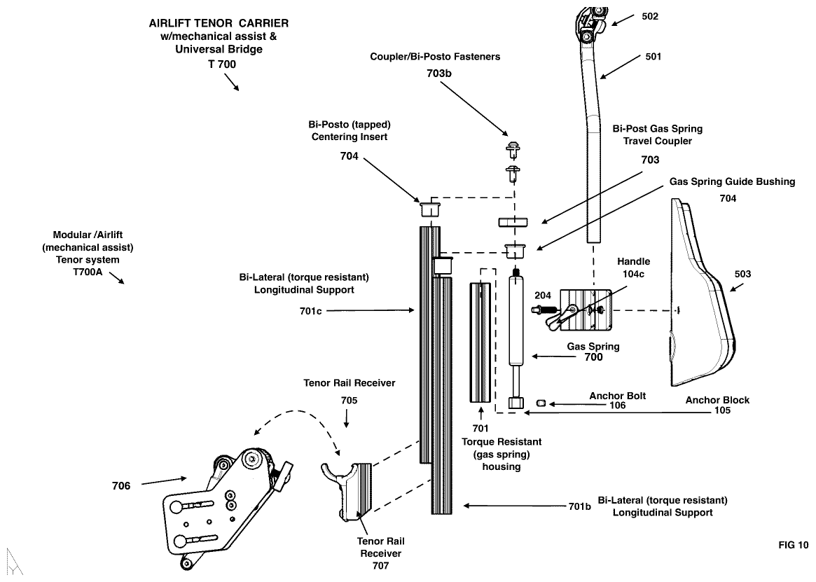

Turning now to FIGS. 9-11, the Universal Modular AIRLIFT TENOR CARRIER T700 is different in structure vs AIRLIFT SNARE CARRIER S500 and AIRLIFT BASS CARRIER B600. Universal Modular AIRLIFT TENOR CARRIER T700 is configured specifically to support marching MULTI-TENOR drums. One example of Multi-Tenor drum carrier is shown in applicant's U.S. Pat. No. 8,646,666 which the entire contents and disclosures are hereby expressly incorporated by reference herein. The Universal Modular AIRLIFT TENOR CARRIER T700 has Modular Airlift Mechanical Assist Tenor System T700A. Tenor System T700A has Air Rest Tenor Rail 706 connected to MULTI-TENOR drums (drums not shown). Exemplary carriers and components of applicant's Air Rest Tenor Rail 706 are described in at least the following, U.S. Pat. No. 9,858,908 filed Jan. 20, 2016, U.S. Pat. No. 10,438,571 filed Dec. 22, 2017.

Air Rest Tenor Rail 706 is supported with Tenor Rail Receiver 705 and interconnected to Bi-Lateral Torque Resistant Longitudinal Supports 701b & 701c via Tenor Rail Collar Coupling Receivers 707. Said Longitudinal Supports 701b & 701c have (tapped) Centering Inserts 704 press-fit into upper ends of Longitudinal Supports 701b & 701c and further secured with heat activated epoxy. Said Longitudinal Supports 701b & 701c slidably interconnect with Modular Torque Resistant Lateral Mounting Receivers 201b & 201c. Lateral Mounting Receivers 201b & 201c are mounted to Modular Universal Bridge 200 at Alignment Mounting Receiver Channels 200b & 200c via Receiver Fasteners 204. Torque Resistant Gas Spring Housing 701 is slidably interconnected with Modular Torque Resistant Mounting Receiver 201a mounted to Modular Universal Bridge 200 at Alignment Mounting Receiver Channel 200a, via Receiver Fasteners 204, Gas Spring 700 is interconnected inside Torque Resistant Gas Spring Housing 701 with Gas Spring 700 screwed into threaded Anchor Block 105. Anchor Block 105 is secured to Torque Resistant Gas Spring Housing 701 via Anchor Block Bolt 106 threaded into both Torque Resistant Gas Spring Housing 701 and Anchor Block 105. Gas Spring Guide Bushing 702 press-fits into upper end of Torque Resistant Gas Spring Housing 701 and further secured with bonding adhesive. Upper end of Gas Spring 700 screws into threaded Bi-Post Gas Spring Travel Coupler Insert 703c. Bi-Post Gas Spring Travel Coupler 703c has Alignment Slots 703a to receive Coupler/Bi-Post Fasteners 703b joining both Bi-Lateral Torque Resistant Longitudinal Supports 701b & 701c. Modular Airlift Mechanical Assist Tenor System T700A structure (upon unitary assembly) requires both Longitudinal Supports 701b & 701c must remain parallel with each corresponding Lateral Mounting Receivers 201b & 201c alignments. Said parallel alignment of Lateral Support 701b & 701c is critical with longitudinal deployment travel (upward/downward). Positioning Lockdown Fasteners 104 are housed in both Modular Torque Resistant Lateral Mounting Receivers 201b & 201c engaging either one or both Lateral Supports 701b & 701c to lock and/or release longitudinal deployment positioning. It should be understood drum positioning range is not only determined by Gas Spring 700 stroke length, but also determined by longitudinal positioning of Torque Resistant Gas Spring Housing 701 to a nominal preferred position and locked into position with Longitudinal Gas Spring Housing Positioning Fasteners 206. Thus, Gas Spring 700 effective stroke length can be further maximized,

Operation for deployment first requires loosening Positioning lockdown Fastener/s 104c, allowing Gas Spring 700 to deploy upward, moving the unitary structure T700A to a desired playing position. Similar with Modular Airlift Mechanical Assists S500A and B600A, T700A structure also allows the cantilevered load of the Tenor drums (positioned in a playing position) to work in tandem with the Gas Spring 700. Said tandem working relationship temporarily holds the reposition deployment of the Modular Airlift Mechanical Assist Tenor System T700A prior to securing the Positioning Lock Down Fastener 104c. This feature allows the performer to implement micro amounts of adjustment to achieve a precise playing height. An additional advantage of said tandem working relationship allows for the gas spring to be of lesser workforce to reposition the Modular Airlift Mechanical Assist Tenor System T700A with supported drums. When the performer loosens the Positioning Lock Down Fastener 104c, followed by a small degree of drum array rotation (approximately 2-5° upward toward the rest position), the cantilevered load is somewhat neutralized, thus allowing the gas spring to mechanically assist repositing system T700a with the drum array. When the performer desires to lower the drum array the drums will now be further rotated to full rest position (upward) 90°, utilizing the vertical load of the drums to neutralize the gas spring upward force and apply modest downward force to reposition the drum array lower. Further advantages as with long parades, the tenor drums can now be lowered well below the desired playing position when rotated upward 90° to further reduce the torque forces acting upon on the performers pivot point (lower back). To reposition the tenor drum array, back up to preferred playing position, performer assists the gas spring upward to memory stop, thus stopping the upper deployment and rotating the drums downward, 90° to playing position.

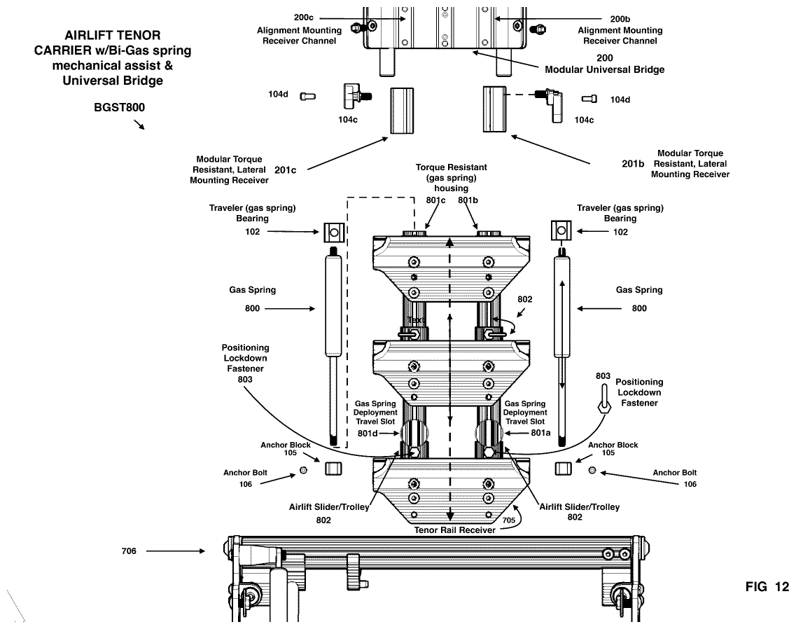

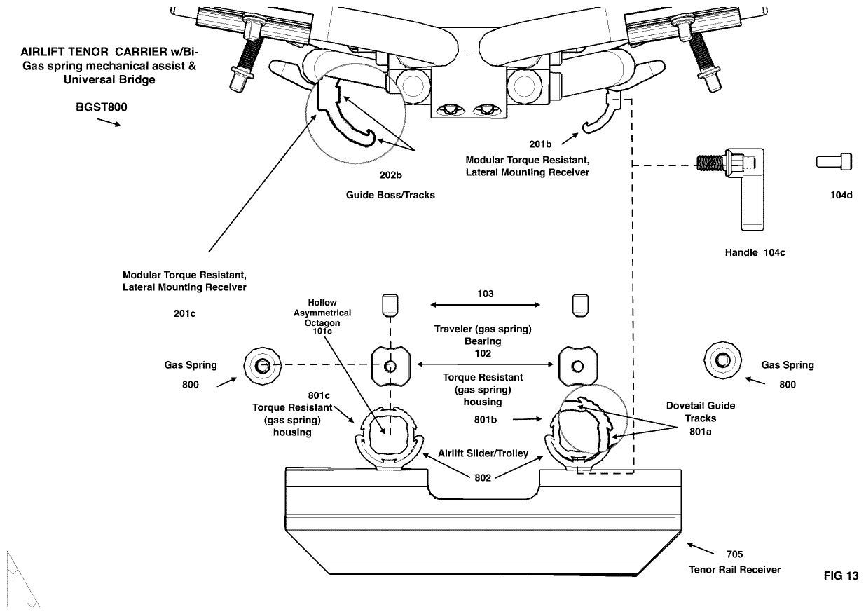

Turning now to FIGS. 12-13, the AIRLIFT TENOR CARRIER BGST800 with Bi-Gas springs 800 and Modular Universal Bridge 200 is also configured to support marching, multi-tenor drums (drums not shown), BGST800 is similar to Airlift Snare Carrier S500 but with two Gas Springs 800. Air Rest Tenor Rail 706 is supported by Tenor Rail Receiver 705 and interconnected to Airlift Slider Trolleys 802 that are slidably interconnected to Torque Resistant Gas Spring Housings 801b and 801c. Torque Resistant Gas Spring Housings 801b and 801c are interconnected to Modular Torque Resistant Mounting Receivers 201b, 201c. Said Mounting Receivers 201b, 201c are mounted to Modular Universal Bridge 200 at Alignment Mounting Receiver Channels 200b & 200c via Receiver Fasteners 204. Longitudinal adjustment of Torque Resistant Gas Spring Housings 801b and 801c are secured with Positioning Lockdown Fastener/s 104c. Said Airlift Slider Trolleys 802 are slidably interconnected to bi-lateral Longitudinal Supports 801b and 801c and secured with Positioning Lockdown Fasteners 803 passing through Gas Spring Deployment Travel Slot 801a, 801d. Gas Springs 800 are interconnected inside Torque Resistant Gas Spring Housings 801b and 801c with Gas Springs 800 screwed into Threaded Anchor Blocks 105. Anchor Blocks 105 are secured into bi-lateral Torque Resistant Gas Spring Housings 801b and 801c via Anchor Bolts 106. Anchor Blocks 105 and Anchor Blots 106 are threaded into both Torque Resistant Gas Spring Housings 801b, 801c to become a unitary interchangeable structure.

Traveler Gas Spring Bearings 102 are threaded onto upper end of Gas Springs 800. Traveler Gas Spring Bearings 102 have matching profiles to inside of Torque Resistant Gas Spring Housings 801b and 801c. Bi-lateral Torque Resistant Gas Spring Housings 801b and 801c are preferably made of lightweight metals, i.e. aluminum or magnesium and Traveler Gas Spring Bearings 102 are preferably constructed of a machinable polymer with good to excellent lubricity as with Teflon or Acetal to mitigate drag/friction in the deployment travel of gas springs 800. Gas Springs 800 OD are undersized to that of Traveler Gas Spring Bearings 102 OD, thus allowing Gas Springs 800 to deploy or compress without interfering inside Hollow Asymmetrical Octagon 101c. Traveler Gas Spring Bearings 102 are also undersized with micro/minimum clearance and further have horizontal pockets to Receive Traveler Insert Cups 103 (preferably constructed from metal) receiving Positioning Lockdown Fasteners 803. Positioning Lockdown Fasteners 803 are threaded into Airlift Slider Trolley 802 and pass through Gas Spring Deployment Travel Slots 801a, 801d and floats into Traveler Insert Cup 103. Interconnected Gas Springs 800 and Airlift Slider Trolleys 802 move together as one embodiment when deploying and/or compressing Gas Springs 800.

To determine the desired position, deploy or compress the Modular Airlift Mechanical Assist System BGST800. Positioning Lockdown Fasteners 803 are rotated clockwise to lock the position of Traveler Gas Spring Bearings 102 with lateral movement (approximately 0.005), positioning/compressing against the inside of Hollow Asymmetrical Octagon 101c wall. Positioning Lockdown Fastener 803 also simultaneously draw Airlift Slider Trolleys 802 away from Torque Resistant Gas Spring Housing 801b, 801c to engage Dovetail Guide Boss/Tracks 801a. Torque Resistant Gas Spring Housings 801b, 801c are locked to secure the position of Modular Airlift Mechanical Assist System BGST800.

As with the Modular Airlift Snare System S500A, Memory Positioning Stop 107 can be positioned on either Torque Resistant Gas Spring Housing 801b, 801c to mechanically interfere/stop Gas Springs 800 deployment to a preset preferred playing height. Memory Positioning Stop 107 allows the performer to lower the drum array's position in real time for visual enhancements and/or to further improve the player's rest position. The performer can adjust the preferred lowered positioning by first compressing Gas Spring 800 (to bottom of stroke) and lock. Lowest height adjustment is performed by positioning Torque Resistant Gas Spring Housing 801b, 801c fully downward longitudinally within Modular Torque Resistant Mounting Receivers 201b, 201c and secured with Longitudinal Gas Spring Housing Positioning Fasteners 104c. Height is dictated by the position of Memory Positioning Stop 107. Performer can now reposition the drum array in real time to both preferred lower and/or higher playing height and vice versa,

Other features and details are readily apparent from the figures and are not discussed in-depth herein for the sake of efficiency. However, all features, structures and operations thereof that would be apparent from this disclosure to one of ordinary skill in the art are expressly contemplated.

The objects, advantages and features described in detail above are considered novel over the prior art of record and are considered critical to the operation of at least one embodiment of the present invention and to the achievement of at least one objective of the present invention. The words used in this specification to describe these objects, advantages and features are to be understood not only in the sense of their commonly defined meanings, but also to include any special definition with regard to structure, material or acts that would be understood by one of ordinary skilled in the art to apply in the context of the entire disclosure.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C. An exception to this definition will occur only when a combination of elements, functions, steps or acts are in some way inherently mutually exclusive.

Reference throughout this document to “one embodiment”, “certain embodiments”, “an embodiment” or similar term means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner on one or more embodiments without limitation.

Moreover, the definitions of the words or drawing elements described herein are meant to include not only the combination of elements which are literally set forth, but all equivalent structures, materials or acts for performing substantially the same function in substantially the same way to obtain substantially the same result. In this sense, it is therefore contemplated that an equivalent substitution of two or more elements may be made for any one of the elements described and its various embodiments or that a single element may be substituted for two or more elements in a claim without departing from the scope of the present invention

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

1. A percussion instrument carrier bridge, comprising:
a bridge body having a plurality of mounting receiver channels; and
a plurality of mounting receivers, wherein each mounting receiver is detachably mountable to a respective mounting receiver channel so as to reconfigure the percussion instrument carrier bridge to support a percussion instrument thereon in playing position.

2. The device of claim 1,
wherein mounting one or more mounting receivers to respective mounting receiver channels in a first configuration reconfigures the percussion instrument carrier bridge to support a first percussion instrument thereon in playing position, and wherein mounting one or more mounting receivers to respective mounting receiver channels in a second configuration reconfigures the percussion instrument carrier bridge to support a second percussion instrument thereon in playing position.

3. The device of claim 2, wherein the first percussion instrument is one of and the second percussion instrument is another of: a snare drum, a tenor drum, and a bass drum.

4. The device of claim 1, wherein each mounting receiver is configured to hold a mechanical assist device that supports the percussion instrument thereon and provides a lifting force to the percussion instrument.

5. The device of claim 1, wherein at least one mounting receiver comprises:
a mounting receiver base configured to mount the at least one mounting receiver to the mounting receiver channel; and
a mounting receiver appendage having a generally concave surface with at least one linear guide protruding therefrom.

6. The device of claim 5, wherein the concave surface is configured to hold therein a mechanical assist device that supports the percussion instrument thereon and provides a lifting force to the percussion instrument.

7. The device of claim 5,
wherein at least one of the mounting receiver channels comprise a first dovetail portion, and
wherein the mounting receiver base includes a second dovetail portion configured to receive the first dovetail portion therein.

8. The device of claim 5, wherein the mounting receiver base comprises a pivot boss about which the mounting receiver appendage is pivotable to permit the mounting receiver appendage to receive and hold therein a mechanical assist device that supports the percussion instrument thereon and provides a lifting force to the percussion instrument.

9. The device of claim 8, wherein the mounting receiver appendage is pivotable to permit the mounting receiver channel to receive and hold therein the mechanical assist device.

10. The device of claim 1, wherein the bridge body comprises a first body removably attached to a second body.

11. A percussion instrument carrier, comprising:
at least one shoulder support configured to rest on a user's shoulders;
a belly plate configured to rest against the user's belly and be supported by the at least one shoulder support;
a bridge having a plurality of configurations, wherein each configuration enables the bridge to couple the belly plate to a different percussion instrument support structure,
wherein the bridge includes:
a bridge body having a plurality of mounting receiver channels, and
a plurality of mounting receivers, wherein each mounting receiver is detachably mountable to a respective mounting receiver channel so as to reconfigure the percussion instrument carrier bridge according to the plurality of configurations.

12. The device of claim 11,
wherein mounting one or more mounting receivers to respective mounting receiver channels in a first configuration reconfigures the percussion instrument carrier bridge to couple the belly plate to a first percussion instrument support structure that supports a first percussion instrument thereon in playing position, and
wherein mounting one or more mounting receivers to respective mounting receiver channels in a second configuration reconfigures the percussion instrument carrier bridge to couple the belly plate to a second percussion instrument support structure that supports a second percussion instrument thereon in playing position.

13. The device of claim 12, wherein the first percussion instrument is one of and the second percussion instrument is another of: a snare drum, a tenor drum, and a bass drum.

14. The device of claim 11, wherein each mounting receiver is configured to hold a percussion instrument support structure that includes a mechanical assist device that supports the percussion instrument thereon and provides a lifting force to the percussion instrument.

15. The device of claim 11, wherein at least one mounting receiver comprises:
a mounting receiver base configured to mount the at least one mounting receiver to the mounting receiver channel; and
a mounting receiver appendage having a generally concave surface with at least one linear guide protruding therefrom.

16. The device of claim 15, wherein the concave surface is configured to hold therein a percussion instrument support structure that includes a mechanical assist device that supports the percussion instrument thereon and provides a lifting force to the percussion instrument.

17. The device of claim 15,
wherein at least one of the mounting receiver channels comprise a first dovetail portion, and
wherein the mounting receiver base includes a second dovetail portion configured to receive the first dovetail portion therein.

18. The device of claim 15, wherein the mounting receiver base comprises a pivot boss about which the mounting receiver appendage is pivotable to permit the mounting receiver appendage to receive and hold therein a percussion instrument support structure that includes a mechanical assist device that supports the percussion instrument thereon and provides a lifting force to the percussion instrument.

19. The device of claim 18, wherein the mounting receiver appendage is pivotable to permit the mounting receiver channel to receive and hold therein the mechanical assist device.

20. The device of claim 11, wherein the bridge body comprises a first body removably attached to a second body.
